(19) United States
(12) Patent Application Publication
(10) Pub. No.: US 2021/0251271 A1
(43) Pub. Date: Aug. 19, 2021

(54) METHOD FOR THE PRODUCTION AND USE OF MYCELIATED MIXED NUTRIENT PRODUCT FOR ENHANCED NUTRIENT SUPPLEMENTS

(71) Applicant: MycoTechnology, Inc., Aurora, CO (US)

(72) Inventors: Bhupendra Kumar SONI, Aurora, CO (US); Anthony J. CLARK, Aurora, CO (US); James Patrick LANGAN, Aurora, CO (US); Brooks John KELLY, Aurora, CO (US); Huntington DAVIS, Aurora, CO (US); Brendan SHARKEY, Aurora, CO (US); Andrew MESTDAGH, Aurora, CO (US); Alan D. HAHN, Aurora, CO (US)

(73) Assignee: MycoTechnology, Inc., Aurora, CO (US)

(21) Appl. No.: 17/055,870

(22) PCT Filed: May 22, 2019
(86) PCT No.: PCT/US2019/033501

§ 371 Date: Nov. 16, 2020

Related U.S. Application Data
(60) Provisional application No. 62/819,352, filed on Mar. 15, 2019.
(60) Provisional application No. 62/676,231, filed on May 24, 2018.

(51) Int. Cl. A23L 31/00; A01G 18/20; A23L 19/00; A23L 5/30; A23L 5/20; A23L 33/15; A23L 33/16

(52) U.S. Cl. CPC A23L 31/00; A01G 18/20; A23L 19/01; A23V 2002/00; A23L 5/20; A23L 33/15; A23L 33/16; A23L 5/36

(57) ABSTRACT

Disclosed is a method to prepare myceliated vegetable product which includes culturing fungi in an aqueous media which contains vegetables, fruits, and/or combinations thereof. Examples of vegetables used in the processes of the invention include carrot, spinach, kale, beet, broccoli, and combinations thereof. Fungi used include Lentinula edodes. The resultant myceliated nutrient food product has its flavor, or aroma modulated, such as by decreasing undesirable flavor of bitterness, beet, hay/herbal/grassy or decreasing undesirable aroma of beet or hay/herbal/grassy. Products made according to the invention have a nutritional profile comprising a measurable level of at least one of potassium, calcium, magnesium, iron, selenium, folate, Vitamin D, Vitamin A, Vitamin E, or Vitamin C, and a dose 10 g of the myceliated vegetable product can provide a significant amount of the daily requirement of certain vitamins and minerals. The product can be added to foods and/or beverages to improve the nutrient composition of foods without adding undesirable tastes or aromas.

### CROSS-REFERENCE TO RELATED APPLICATIONS

This application claims the benefit of and priority to U.S. Provisional Patent Application No. 62/676,231, filed May 24, 2018, and U.S. Provisional Patent Application No. 62/819,352, filed Mar. 15, 2019, which are specifically incorporated by reference in their entirety to the extent not inconsistent herewith.

### BACKGROUND OF THE INVENTION

There is a growing need for efficient, high quality natural nutrient supplements or vitamins with acceptable levels of nutrients, together with acceptable taste, flavor and/or aroma profiles. However, it has proven difficult to achieve such products, particularly with multiple vitamins, minerals, and phytonutrients using natural processes; and a synthetic mixture is often too bitter or astringent to consume in sufficient doses or in a convenient format. Synthetic products also suffer from poor bioavailability. Products available as mixtures of vegetables/fruits are often very bitter and/or astringent and have pungent aromas and are therefore unpalatable. Therefore, there is a need for efficient, high quality and low cost natural nutrient food sources with acceptable taste, flavor and/or aroma profiles, and good nutritional profiles, and for a process that enables the myceliation of highly vegetable/fruit mixture media, specifically media that are greater than 10% to 30% solids on a dry weight basis.

Vitamin D, which regulates the way calcium and phosphate are metabolized, is essential for human health. Vitamin D deficiency or insufficiency has been associated with disorders such as rickets in children and osteoporosis in adults and has also been proven to be linked with other disorders such as certain types of cancers, heart diseases, diabetes, and obesity. Humans mainly obtain vitamin D through cutaneous synthesis by sunlight exposure. However, many people are unable to get enough sunlight exposure for production of adequate levels of vitamin D owing to their ethnicity, living conditions, age, and use of sunscreen. Under these circumstances, a dietary intake of vitamin D is essential. However, only few types of natural foods, such as oil-rich fish, fish liver oils, and egg yolks, provide a relatively useful amount of vitamin D. This suggests that people who eat non-vegetarian food can easily consume vitamin D through food sources, whereas people who refrain from eating animal products are more vulnerable to vitamin D deficiency disorders. There are two primary types of vitamin D: vitamin D₂ and vitamin D₃. The former can be synthesized from a fungal sterol called ergosterol via ultraviolet irradiation; whereas the latter is mainly obtained from the transformation of cholesterol in the skin under sunlight exposure. Vitamin D2 is considered to behave in a similar biological manner as vitamin D₃. Both of them can be transformed into a metabolite of 25-hydroxyvitamin D in the liver, which is considered as the functional indicator of dietary reference for vitamin D intake. Accordingly, there is also a need for vegetarian sources of Vitamin D.

### SUMMARY OF THE INVENTION

In one embodiment, the present invention provides a method to prepare a myceliated vegetable-containing product, comprising the steps of: (a) providing an aqueous medium comprising at least one vegetable substance; (b) inoculating the medium with a fungal culture, wherein the fungal culture comprises Agaricus spp., Pleurotus spp., Boletus spp., or Laetiporus spp.; or wherein the fungal culture comprises Lentinula edodes, Hericium erinaceus, Inonotus obliquus, Ganoderma lucidum, or Cordyceps sinensis; and (c) culturing the medium to produce a myceliated vegetable-containing product. In embodiments, the myceliated vegetable-containing product has (i) reduced undesirable flavors and/or reduced undesirable aromas, compared to a non-myceliated vegetable-containing product, or (ii) a nutritional profile comprising a measurable level of at least one of potassium, calcium, magnesium, iron, selenium, folate, Vitamin D, Vitamin A, Vitamin E, or Vitamin C. In embodiments, the myceliated vegetable product has Vitamin D at a level of at least 0.1 microgram/g dry weight.

In other embodiments, the myceliated vegetable product has at least one of one of potassium at a level of least 10 mg/g dry weight, calcium at a level of at least 0.5 mg/g dry weight, magnesium at a level of at least 1.5 mg/g dry weight, iron at a level of at least 50 microgram/g dry weight, selenium at a level of at least 0.1 microgram/g dry weight, folate at a level of at least 0.5 microgram/g dry weight, Vitamin D at a level of at least 0.05 microgram/g dry weight, Vitamin A at a level of at least 1 microgram/g dry weight, Vitamin E at a level of at least 20 microgram/g dry weight, Vitamin K at a level of at least 1 microgram/g dry weight, or Vitamin C at a level of at least 0.1 mg/g dry weight.

In embodiments, the aqueous media comprises between about 5 g to about 100 g (dry weight) vegetable substance in total per L aqueous medium. In other embodiments, the vegetable substance comprises one or more of carrot, spinach, kale, beet, celery, broccoli, aronia, grape skin, apple skin, cauliflower, sauerkraut, radish, kiwi, raspberry, cherry, mango, mandarin, banana, papaya, watercress, Chinese cabbage, chard, beet greens, chicory, leaf lettuce, parsley, romaine lettuce, collard greens, turnip greens, mustard greens, endive, chive, dandelion, sunflower, bell pepper, arugula, pumpkin, brussel sprout, scallion, kohlrabi, cabbage, winter squash (all varieties), rutabaga, turnip, leeks, sweet potato, fennel, swiss chard, okra, zucchini, avocado, bok choy, asparagus, pear, avocado, blueberry, blackberry, strawberry, raspberry, apricot, peach, red kale, purple beet, purple kale, rhodiola root, ashwagandha, coriander, cardamom, mint, turmeric, ascia, chokecherry, cinnamon, neem, aloe vera, anise, ajwain, turmeric, mustard seeds, cumin seeds, black pepper, kokum, tamarind, poppy seeds, ginger, Siberian ginseng, Asian ginseng, or a combination thereof, each of which are optionally in the form of a dried powder prior to addition to the media.

In embodiments, the vegetable substance comprises a mixture of dried or fresh spinach, broccoli, kale, and beet root. In other embodiments, the aqueous media comprises 1-50 g/L spinach powder, 1-50 g/L broccoli powder, 1-50 g/L kale powder, and 1-50 g/L beet root powder. In an embodiment, an improved nutritional profile comprises increased amounts of or increased bioavailability of flavonoids, carotenoids or other phytonutrients.

In embodiments of the present invention, the Laetiporus spp. is Laetiporus sulfureus, the Pleurotus spp. comprises Pleurotus ostreatus, Pleurotus salmoneostramineus (Pleurotus djamor), Pleurotus eryngii, or Pleurotus citrinopileatus, the Boletus spp. comprises Boletus edulis and wherein the Agaricus spp. comprises Agaricus blazeii, Agaricus bisporus. Agaricus campestris, Agaricus subrufescens, Agaricus brasiliensis or Agaricus silvaticus. In an embodiment, the fungal culture comprises L. edodes.

In an embodiment, the reduced undesirable flavor comprises a reduced beet, bitter, astringent, hay/herbal/grassy taste; the reduction can be at least 20%, or at least 50%. In another embodiment, the reduced undesirable aroma comprises a decrease in beet, hay/herbal/grassy aroma; the reduction can be at least 20%, or at least 50%.

In an embodiment, the method can further comprise step (d), exposing the myceliated vegetable-containing product to UV light sufficient to convert a proportion of the myceliated vegetable-containing product's ergosterol to Vitamin D. The method may also further comprise the step of adding to the UV-treated myceliated vegetable-containing product a material selected from the group consisting of fresh or dried carrot powder, Vitamin E, and Vitamin C.

In an embodiment, the aqueous media is pasteurized prior to the inoculating step. Optionally, the myceliated vegetable-containing product is pasteurized and may be optionally dried. Drying can be by any method in the art, preferably a lower temperature drying to preserve nutritional qualities. These include vacuum drying, low temperature vacuum drying.

In an embodiment, the aqueous medium additionally comprises an ingredient selected from the group consisting of a ferrous salt and a potassium salt.

In specific embodiments, the present invention includes a method to prepare a myceliated vegetable-containing product, comprising the steps of: (a) providing an aqueous medium comprising 1-50 g/L dried carrot powder, 1-50 g/L dried spinach powder, 1-50 g/L dried broccoli powder, 1-50 g/L dried kale powder, and 1-50 g/L dried beet root powder, a ferrous salt and a potassium salt; (b) pasteurizing the aqueous medium; (c) inoculating the medium with a fungal culture comprising L. edodes; (d) culturing the medium to produce an improved myceliated vegetable-containing product, (e) exposing product of step (d) to UV light; (f) adding to the product of step (e) at least one of dried carrot powder at 1-50 g/l, Vitamin C, and Vitamin E; (g) pasteurizing the product of step (f); and (h) drying the product of step (g) by a low-temperature drying step, wherein the myceliated vegetable product has at least one of one of potassium at a level of least 10 mg/g dry weight, calcium at a level of at least 0.5 mg/g dry weight, magnesium at a level of at least 1.5 mg/g dry weight, iron at a level of at least 50 microgram/g dry weight, selenium at a level of at least 0.1 microgram/g dry weight, folate at a level of at least 0.5 microgram/g dry weight, Vitamin D at a level of at least 0.05 microgram/g dry weight, Vitamin A at a level of at least 1 microgram/g dry weight, Vitamin E at a level of at least 20 microgram/g dry weight, Vitamin K at a level of at least 1 microgram/g dry weight, or Vitamin C at a level of at least 0.1 mg/g dry weight.

The present invention also includes a myceliated vegetable-containing product prepared by any of the methods disclosed herein. Also provided herein is a myceliated vegetable-containing product comprising a mixture of carrot, spinach, celery, kale, beet root, and a fungal culture comprising L. edodes; wherein the myceliated vegetable-containing product has reduced beet and hay/herbal/grassy tastes, reduced beet and hay/herbal/grassy aromas, and wherein the myceliated vegetable product has at least one of one of potassium at a level of least 10 mg/g dry weight, calcium at a level of at least 0.5 mg/g dry weight, magnesium at a level of at least 1.5 mg/g dry weight, iron at a level of at least 50 microgram/g dry weight, selenium at a level of at least 0.1 microgram/g dry weight, folate at a level of at least 0.5 microgram/g dry weight, Vitamin D at a level of at least 0.05 microgram/g dry weight, Vitamin A at a level of at least 1 microgram/g dry weight, Vitamin E at a level of at least 20 microgram/g dry weight, Vitamin K at a level of at least 1 microgram/g dry weight, or Vitamin C at a level of at least 0.1 mg/g dry weight.

### BRIEF DESCRIPTION OF THE FIGURES

FIG. 1 shows a general schematic of how to select ingredients for the nutrient boost material of the present invention.

FIG. 2 shows a schematic of a process to make the nutrient boost material of the invention.

FIG. 3 shows a sample nutritional analysis of a product of the present invention.

### DETAILED DESCRIPTION OF THE INVENTION

In general, the terms and phrases used herein have their art-recognized meaning, which can be found by reference to standard texts, journal references and contexts known to those skilled in the art. The following definitions are provided to clarify their specific use in the context of the invention.

The present inventors have found that culturing a fungus in a vegetables and/or fruits or mixtures thereof provides an economically viable, high nutrient-containing product and found that such treatment can surprisingly provide excellent taste, flavor or aroma in unexpected ways. The process additionally enables the production of nutrient rich supplements and/or foodstuffs that have been incorporated with mycelial material. This in turn, alters aspects of the media used in the production of products according to the methods of the present invention. The present invention, through careful media selection, can fulfill the daily requirement of several vitamins and minerals and phytonutrients up to 100% (U.S. RDA, as generally known in the art).

In embodiments, the present invention utilizes raw vegetables (e.g., in powdered form, and reconstituted in a medium) a fermentation process that includes adding mature filamentous Shiitake (Lentinula edodes) cultures to the media containing the vegetable powders to create a nutrient boost powder that comes from a mix of vegetables and mushroom mycelia.

In the present invention, the present inventors have created a nutrient “boost” material, for example, a powder, containing targeted amounts of essential nutrients such as: potassium, iron, calcium, Vitamin E, Vitamin C, folate, Vitamin A, Vitamin K, and/or magnesium with a serving size of less than 10 grams, which can be optionally used to add to other foods as a supplement, but having reduced vegetal, beany, bitter flavors and aromas. Optionally Vitamin D can be included.

In one embodiment, the present invention includes a method to prepare a myceliated high-nutrient product, e.g., a myceliated vegetable-containing product. The method may optionally include the steps of providing an aqueous media comprising one or more of vegetables or fruits, or vegetable substances or fruit substances. The aqueous media may comprise, consist of, or consist essentially of at least 5 g each of vegetable substance(s) and/or fruit substance(s) per 100 g solids, or 5 g/L medium on a dry weight basis. The media may also comprise, consist of or consist essentially of optional additional excipients as identified herein below. The aqueous media may be inoculated with a fungal culture, optionally, a culture comprising, consisting essentially of, or consisting of Lentinula edodes, Agaricus spp., Pleurotus spp., Boletus spp., or Laetiporus spp., or Hericium erinaceus, Inonotus obliquus, Ganoderma lucidum, or Cordyceps sinensis. The inoculated media may then be cultured to produce a myceliated vegetable-containing product, and the myceliated vegetable-containing product has optionally (i) reduced undesirable flavors and/or reduced undesirable aromas, compared to a non-myceliated vegetable-containing product, or (ii) a nutritional profile comprising a measurable level of at least one of potassium, calcium, magnesium, iron, selenium, folate, Vitamin D, Vitamin A, Vitamin E, or Vitamin C.

The aqueous media may comprise, consist of, or consist essentially of one or more (e.g., a mixture) of vegetables and/or fruits materials or substances. The vegetable/fruit materials or substances to include in the aqueous media can be obtained from any of several vegetable or fruit sources and can include a one or more of the vegetables/fruits in whole form (fresh), as extracts, or dried or partially dried form from whole vegetables or extracts, e.g., powders. Vegetables and fruits suitable for the present invention include any prepared from a vegetarian source such as carrot, spinach, kale, beet, celery, broccoli, aronia, grape skin, apple skin, cauliflower, sauerkraut, radish, kiwi, raspberry, cherry, mango, mandarin, banana, papaya, watercress, Chinese cabbage, chard, beet greens, chicory, leaf lettuce, parsley, romaine lettuce, collard greens, turnip greens, mustard greens, endive, chive, dandelion, sunflower, bell pepper, arugula, pumpkin, brussel sprout, scallion, kohlrabi, cabbage, winter squash (all varieties), rutabaga, turnip, leeks, sweet potato, fennel, swiss chard, okra, zucchini, avocado, bok choy, asparagus, pear, avocado, blueberry, blackberry, strawberry, raspberry, apricot, peach, red kale, purple beet, purple kale, rhodiola root, ashwagandha, coriander, cardamom, mint, turmeric, ascia, chokecherry, cinnamon, neem, aloe vera, anise, ajwain, turmeric, mustard seeds, cumin seeds, black pepper, kokum, tamarind, poppy seeds, ginger, Siberian ginseng, Asian ginseng, or a combination thereof. A typical vegetable/fruit powder is typically dried or spray dried and is available in a powdered form and may alternatively be called “vegetable powder.”

In embodiments, the vegetable substances may comprise a combination of 1-50 g/L spinach powder, 1-50 g/L broccoli powder, 1-50 g/L kale powder, and 1-50 g/L beet root powder, all dry weight. In embodiments, each of the powders (spinach, broccoli, kale, and beet root) are each at 14 g/L.

In one embodiment, the myceliated vegetable-containing products as disclosed herein can be used to provide, for example, favorable qualities of nutrients when added to foods and/or beverages. Nutrients include any nutrient and can include, for example, Vitamin A, folate, niacin, pantothenic acid, riboflavin, thiamin, Vitamin B6, Vitamin B12, Vitamin C, Vitamin D, Vitamin E and Vitamin K, copper, iodine, potassium, calcium, magnesium, iron, selenium. The myceliated vegetable-containing product can also provide phytonutrients such as flavonoids, carotenoids or other phytonutrients, such as resveratrol, stilbenes, flavanols, anthocyanins, or polymethoxylated flavones. Certain fungal metabolites may be present depending on species and strain used, for example, ergosterol, which is a precursor to Vitamin D production.

The myceliated vegetable-containing product may fulfill the daily requirement of, for example, at least 5%, at least 10%, at least 20%, at least 30%, at least 40%, at least 50%, at least 60%, at least 70%, at least 80%, at least 90%, at least 100%, at least 150%, at least 200%, or at about 10% to 20% or 50% to 500% of one or more of the nutrients described above. In embodiments, the myceliated vegetable product has at least one of potassium at a level of least 10 mg/g dry weight, calcium at a level of at least 0.5 mg/g dry weight, magnesium at a level of at least 1.5 mg/g dry weight, iron at a level of at least 50 microgram/g dry weight, selenium at a level of at least 0.1 microgram/g dry weight, folate at a level of at least 0.5 microgram/g dry weight, Vitamin D at a level of at least 0.05 microgram/g dry weight, Vitamin A at a level of at least 1 microgram/g dry weight, Vitamin E at a level of at least 20 microgram/g dry weight, Vitamin K at a level of at least 1 microgram/g dry weight, or Vitamin C at a level of at least 0.1 mg/g dry weight.

This invention discloses the use of optionally, concentrated media, which can provide, for example, an economically viable process for production of an acceptably tasting and/or flavored myceliated vegetable-containing food product. In one embodiment of the invention the amount of a vegetable and/or fruit substance, or mixture thereof, in the medium has a concentration of up to 300 g/L but fermentation can also be performed at lower levels, such as 10 g/L. Higher concentrations in media result in a thicker and/or more viscous media, and therefore are optionally processed by methods known in the art to avoid engineering issues during culturing or fermentation. The amount used may be optionally chosen to maximize the amount of vegetable substance or material that is cultured, while minimizing technical difficulties in processing that may arise during culturing such as viscosity, foaming and the like. The amount to use can be determined by one of skill in the art and will vary depending on the method of fermentation.

The amount of total vegetables or fruits in the aqueous media may comprise, consist of, or consist essentially of at least 20 g, 25 g, 30 g, 35 g, 40 g, 45 g, 50 g, 55 g, 60 g, 65 g, 70 g, 75 g, 80 g, 85 g, 90 g, 95 g, 100 g, or more, of dry weight vegetable such as vegetable powder per liter of medium. Alternatively, the amount of vegetables or fruits comprises, consist of, or consist essentially of between 5 g to 100 g, between 10 g and 70 g, between 20 g and 60 g, between 30 g and 50 g, of vegetable per liter medium.

In some embodiments, the total vegetable/fruit in aqueous media is about 20 g to about 250 g, or about 35 to 250 g dry weight per liter of medium.

In some embodiments, the input material (such as the vegetable substance(s)), after preparing the aqueous media of the invention, is not completely dissolved in the aqueous media. Instead, the input material may be partially dissolved, and/or partially suspended, and/or partially colloidal. However, even in the absence of complete dissolution of the input material, positive changes may be affected during culturing of the media. In one embodiment, the input material in the aqueous media is kept as homogenous as possible during culturing, such as by ensuring agitation and/or shaking.

In one embodiment, the aqueous media further comprises, consists of, or consists essentially of materials other than the vegetables or fruits substances, e.g., excipients as defined herein and/or other substances for enhancing the nutritional profile of the myceliated vegetable-containing product, as defined herein. Excipients are preferably food-grade and can comprise any other components known in the art to potentiate and/or support fungal growth, and can include, for example, nutrients, such as proteins/peptides, peptones, yeast extracts, lecithin, and the like; energy sources known in the art, such as carbohydrates, such as maltodextrin, starch, dextrose; essential metals and minerals as known in the art, which includes, for example, calcium, magnesium, iron, trace metals, phosphates; buffering agents as known in the art, such as phosphates, acetates, and optionally pH indicators. It is usual to add pH indicators to such formulations.

Excipients may also include peptones/proteins/yeast extract, as is known in the art. These are usually added as a mixture of protein hydrolysate (peptone, hydrolyzed vegetable protein [HVP], bouillon, etc.) and meat infusion, however, as used in the art, these ingredients are typically included at levels that result in much lower levels of nutrients in the product than is disclosed herein.

In one embodiment, excipients comprise, consist of, or consist essentially of carrot, spinach, kale, beet, celery, broccoli, aronia, grape skin, apple skin, cauliflower, sauerkraut, radish, kiwi, raspberry, cherry, mango, mandarin, banana, papaya, watercress, Chinese cabbage, chard, beet greens, chicory, leaf lettuce, parsley, romaine lettuce, collard greens, turnip greens, mustard greens, endive, chive, dandelion, sunflower, bell pepper, arugula, pumpkin, brussel sprout, scallion, kohlrabi, cabbage, winter squash (all varieties), rutabaga, turnip, leeks, sweet potato, fennel, swiss chard, okra, zucchini, avocado, bok choy, asparagus, pear, avocado, blueberry, blackberry, strawberry, raspberry, apricot, peach, red kale, purple beet, purple kale, rhodiola root, ashwagandha, coriander, cardamom, mint, turmeric, ascia, chokecherry, cinnamon, neem, aloe vera, anise, ajwain, turmeric, mustard seeds, cumin seeds, black pepper, kokum, tamarind, poppy seeds, ginger, Siberian ginseng, Asian ginseng, or a combination thereof. In another embodiment, excipients comprise, consist of, or consist essentially of dry carrot powder between 5-100 g/L, kale powder between 5-100 g/L, spinach powder between 5-100 g/L, broccoli powder between 5-100 g/L, and beet powder between 5-100 g/L. Excipients may also optionally comprise, consist of, or consist essentially of an anti-foam component.

In embodiments, substances for enhancing the nutritional profile of the myceliated vegetable-containing product include any substance capable of enhancing a nutritional profile of a food or beverage, and includes, any vitamin or any mineral desired or necessary for human nutrition, as known in the art, for example, potassium, calcium, magnesium, iron, selenium, folate, Vitamin D, Vitamin A, Vitamin E, or Vitamin C. Optionally, such materials may also be added to the myceliated vegetable-containing substance following the fermentation step.

In an embodiment of the method, after the culturing step, the myceliated vegetable-containing product is treated to increase the amount of Vitamin D in the culture. The fungal biomass produced or introduced into the aqueous medium during the inoculation and/or culturing step contains ergosterol. Ergosterol may be converted to Vitamin D by methods known in the art, e.g., by exposure of the myceliated vegetable-containing product to UV light. When fungi are exposed to UV radiation, provitamin D₂ is converted to previtamin D₂. Once formed, previtamin D₂ rapidly isomerizes to vitamin D₂ in a similar manner that previtamin D₃ isomerizes to vitamin D₃ in human skin. Shiitake mushrooms not only produce vitamin D₂ but also produce vitamin D₃ and vitamin D₄. The art shows that bioavailability of vitamin D₂ in mushrooms compared with the bioavailability of vitamin D₂ or vitamin D₃ in a supplement are the same.

The myceliated vegetable-containing product can be treated according to methods known in the art to convert at least a portion of the ergosterol to Vitamin D. In one embodiment, the myceliated vegetable-containing product is exposed to UV light sufficient to convert at least a portion of the myceliated vegetable-containing product's ergosterol to Vitamin D. The conditions, equipment and other variables can be adjusted per known protocols to produce the desired level of Vitamin D. In one embodiment, the myceliated vegetable-containing product may be in aqueous form, concentrated form, or dried form prior to exposure to UV light. Conditions and equipment for UV exposure can be developed to provide appropriate amounts of UV light to the myceliated vegetable-containing product for development of the desired level of Vitamin D, whether or not it has been further processed following the culturing step, e.g., whether it is in dried form, including the particle size of the dried form, or whether myceliated vegetable-containing product is still in aqueous culture, or, alternatively, concentrated of the. Variables to consider also include the total amount of ergosterol present in the myceliated vegetable-containing product and also the time, intensity, and wavelength of the UV lamp. In one embodiment, the desired level of Vitamin D at a level of at least 0.01, 0.05, 0.1, 0.2, 0.3, 0.4, 0.5 microgram/g dry weight of myceliated vegetable-containing product.

For example, if the myceliated vegetable-containing product is exposed to UV light in a dried form, the equipment to use to expose to UV light can include laboratory scale UV Transilluminators, with a UV wavelength of 302 nm, UV Tubes: 5×8 W, Power: 100-240V, 50-60 Hz, exposure pan has dimension of 8 inch by 6.5 inches, using 1-25 cycles (250 seconds each). Samples of the myceliated vegetable-containing product can be tested to determine the optimal UV exposure to develop the desired Vitamin D levels. For example if the myceliated vegetable-containing product is exposed to UV light in an aqueous form, the equipment to use to expose to UV light can include a device including at least one UV lamp encased in a quartz sleeve with liquids pumped through a chamber exposed to the UV lamp in such a way as to create turbulent flow thin films to expose all portions of the liquid to the UV lamp. A number of devices may be used in series to achieve the desired. UV treatment. The liquid may also be circulated more than once to achieve the desired level of Vitamin D. In general, UV dose cannot be measured directly but can be inferred based on the known or estimated inputs to the process, such as flow rate (contact time), transmittance (light reaching the target), turbidity (cloudiness) and lamp age, fouling and outages.

It is known that a number of vitamins, for example, are susceptible to degradation by UV light. For example, Vitamin C, Vitamin E, and Vitamin A can be degraded by UV light. Therefore, in some embodiments, if a substance capable of enhancing a nutritional profile of a food or beverage substance is UV-light labile, the substance may be added subsequent to the UV exposure step. In an embodiment, the UV-labile substances may be added in the form of a vegetable or fruit substance that contains levels of that substance. For example, carrot may be added to enhance Vitamin A content of the material to levels as disclosed in the invention.

The method may also comprise the optional step of sterilizing the aqueous media prior to inoculation by methods known in the art, including steam sterilization and all other known methods to allow for sterile procedure to be followed throughout the inoculation and culturing steps to enable culturing and myceliation by pure fungal strains. Alternatively, the components of the media may be separately sterilized, and the media may be prepared according to sterile procedure. The sterilization process may include continuous sterilization methods well known in the art of elimination microbial load from the vegetable/fruit powders.

Alternatively, the aqueous media may be pasteurized by methods known in the art, for example, 75° C. for 70 minutes, for example. Alternatively, some elements of the media, such as the container, water, and non-heat labile substances (such as, for example, a substance capable of enhancing a nutritional profile, for example, a mineral or mineral salt as disclosed herein) may be sterilized, while the vegetable and/or fruit substance(s) may be pasteurized.

The method also includes inoculating the vegetable/fruit media with a fungal culture. The fungal culture may be prepared by culturing by any methods known in the art. In one embodiment, the methods to culture may be found in, e.g., U.S. Publication No. US 2018/0303044, published Oct. 25, 2018, or U.S. Pat. No. 10,010,103, all of which are incorporated by reference herein in their entireties.

The fungal cultures, prior to the inoculation step, may be propagated and maintained as is known in the art. In one embodiment, the fungi discussed herein can be kept on 2-3% (v/v) fruit puree with 3-4% agar (m/v). Such media is typically prepared in 2 L handled glass jars being filled with 1.4-1.5 L media. Such a container pours for 50-60 90 mm Petri plates. The media is first sterilized by methods known in the art, typically with an autoclave. Conventional B. stearothermophilus and thermocouple methods are used to verify sterilization parameters. Agar media can also be composed of high-protein material to sensitize the strain to the final culture. This technique may also be involved in strain selection of the organisms discussed herein. Agar media should be poured when it has cooled to the point where it can be touched by hand (˜40 to 50° C.).

In one embodiment, maintaining and propagating fungi for use for inoculating the high-vegetable/fruit mixture is described.

As disclosed in the present invention, propagation may be carried out as follows. For example, a propagation scheme that can be used to continuously produce material according to the methods is discussed herein. Once inoculated with master culture and subsequently colonized, Petri plate cultures can be used at any point to propagate mycelium into prepared liquid media. As such, plates can be propagated at any point during log phase or stationary phase but are encouraged to be used within three months and in another embodiment within 2 years, though if properly handled by those skilled in the art can generally be stored for as long as 10 years at 4° C. and up to 6 years at room temperature. In another embodiment these cultures may be preserved in liquid nitrogen and can be stored for 10 years at −80 C.

In some embodiments, liquid cultures used to maintain and propagate fungi for use for inoculating the high-vegetable/fruit mixture material as disclosed in the present invention include undefined agricultural media with optional supplements as a motif to prepare culture for the purposes of inoculating solid-state material or larger volumes of liquid. In some embodiments, liquid media preparations are made as disclosed herein. Liquid media can be also sterilized and cooled similarly to agar media. Like agar media it can theoretically be inoculated with any fungal culture so long as it is deliberate and not contaminated with any undesirable organisms (fungi inoculated with diazotrophs may be desirable for the method of the present invention). As such, liquid media are typically inoculated with agar, liquid and other forms of culture. Bioreactors provide the ability to monitor and control aeration, agitation, foam, temperature, and pH and other parameters of the culture and as such enables shorter myceliation times and the opportunity to make more concentrated media.

In one embodiment, the fungi for use for inoculating the high-vegetable/fruit mixture material as disclosed in the present invention may be prepared as a submerged liquid culture and agitated on a shaker table, or may be prepared in a shaker flask, by methods known in the art and according to media recipes disclosed in the present invention. The fungal component for use in inoculating the aqueous media of the present invention may be made by any method known in the art. In one embodiment, the fungal component may be prepared from a glycerol stock, by a simple propagation motif of Petri plate culture to 0.25-4 L Erlenmeyer shake flask to 50% glycerol stock. Petri plates can comprise agar in 10-45 g/L in addition to various media components. In another embodiment, liquid nitrogen preserved material stored between 1 and 3652 days may be thawed and used within 10 to 30 minutes after thawing. Conducted in sterile operation, chosen Petri plates growing anywhere from 1-^{˜}3,652 days can be propagated into 0.25-4 L Erlenmeyer flasks (or 250 to 1,000 mL Wheaton jars, or any suitable glassware) for incubation on a shaker table or stationary incubation. The smaller the container, the faster the shaker should be. In one embodiment, the shaking is anywhere from 60-160 RPM depending on container size and, with about a 1″ swing radius. In another embodiment the shaking can be done at lower temperature incubators at 15-17° C.

The culturing step of the present invention may be performed by methods (such as sterile procedure) known in the art and disclosed herein and may be carried out in a fermenter, shake flask, bioreactor, or other methods. In a shake flask, in one embodiment, the agitation rate is 70 to 200 RPM, or 85 to 95 RPM, and incubated for 1 to 30 days. In another embodiment the incubation temperature is 15° C. to 30° C. In another embodiment the incubation temperature is 24-26° C. The incubation temperature can be maintained by jacketed water flow or direct steam injection into bioreactor. Liquid-state fermentation agitation and swirling techniques as known in the art are also employed which include mechanical shearing using magnetic stir bars, stainless steel impellers, injection of sterile high-pressure air, the use of shaker tables and other methods such as lighting regimen, batch feeding or chemostatic culturing, as known in the art.

In one embodiment, culturing step is carried out in a bioreactor which is ideally constructed with a torispherical dome, cylindrical body, and spherical cap base, jacketed about the body, equipped with a magnetic drive mixer, any kind of impeller well-known in the art of mixing and ports to provide access for equipment comprising DO, pH, temperature, level and conductivity meters as is known in the art. Any vessel capable of executing the methods of the present invention may be used. Other engineering schemes known to those skilled in the art may also be used.

As used herein, the terms “culturing,” “myceliation,” and “fermentation,” are used interchangeably. All these terms refer to a process of bulk growth or maintenance of microorganisms, which can be single celled or multicellular, including, without limitation, the fungi referred to herein, on a medium. Growth or maintenance can refer to organisms in all growth phases, e.g., lag phase, log phase, or stationary phase.

The reactor can be outfitted to be filled with water. The water supply system is ideally water for injection (WFI) system, with a sterilizable line between the still and the reactor, though RO, soft or any potable water source may be used so long as the water is sterile. In one embodiment the entire media is sterilized in situ while in another embodiment concentrated media is sterilized and diluted into a vessel filled water that was filter and/or heat sterilized, or sufficiently treated so that it doesn't encourage contamination over the colonizing fungus. In another embodiment, high temperature high pressure sterilizations are fast enough to be not detrimental to the media. In one embodiment the entire media is sterilized in continuous mode by applying high temperature between 130° and 145° C. for a residence time of 0.5 to 20 minutes. Once prepared with a working volume of sterile media, the tank can be mildly agitated and inoculated. Either as a concentrate or whole media volume in situ, the media can be heat sterilized by steaming either the jacket, chamber or both while the media is optionally agitated. The medium may optionally be pasteurized at 70°-80° C. instead.

In one embodiment, the reactor is used at a large volume, such as in 10,000-100,000 L working volume bioreactors. When preparing material at such volumes the culture must pass through a successive series of larger bioreactors, any bioreactor being inoculated at 1-10% of the working volume according to the parameters of the seed train. A typical process would pass a culture from master culture, to Petri plates, to flasks, to seed bioreactors to the final main bioreactor when scaling the method of the present invention. To reach large volumes, 2-3 seeds may be used. The media of the seed can be the same or different as the media in the main. In one embodiment, the fungal culture for the seed is a protein concentration as defined herein, to assist the fungal culture in adapting to high-vegetable/fruit mixture media in preparation for the main fermentation. Such techniques are discussed somewhat in the examples below. In one embodiment, foaming is minimized by use of antifoam on the order of 0.1 to 0.5 g/L of media, such as those known in the art, including insoluble oils, polydimethylsiloxanes and other silicones, certain alcohols, stearates and glycols. In one embodiment, lowering pH assists in culture growth, for example, for L. edodes pH may be adjusted by use of citric acid or by any other compound known in the art, but care must be taken to avoid a sour taste for the myceliated high-nutrient product. The pH may be adjusted to between about 5 and 5.5, for example, to assist in growth.

In one embodiment, the process for preparing the fungal culture for inoculating into the aqueous media as described by the invention includes a method of successive fermentations of a primary culture of mycelia of a fungi disclosed herein to build up an amount of a mycelial biomass, followed by a main fermentation step where the built-up shiitake mycelia biomass is inoculated into the sterile and/or pasteurized aqueous media as described herein and allowed to ferment for an appropriate period of time, for example, from 10 to 40 hours. The main fermentation step allows the mycelia biomass developed from the initial fermentations to improve the organoleptic qualities (as measured by human sensory testing) of the input vegetable substances.

In embodiments, the fungal culture may be initiated by starting the growth of pure cultures of mycelia of a fungal species as disclosed herein, e.g., Shiitake (L. edodes) on agar plates developed from a confirmed spawn culture stored at −70° C. The grown cultures on agar plates may be used to initiate liquid cultures of mycelia in shake flasks. The inoculated shake flasks may be incubated at 26° C. for 11 to 13 days using agitation. Once the mycelia has achieved the desired level of growth in the shake flasks, the entirety of the volume of the shake flasks may be transferred into the first of three “seed development” bioreactors to continue to build mycelia biomass. The mycelia biomass building process may be continued in the “seed development” bioreactor process using, for example, three separate fermentations in three bioreactors, each of which are larger in size, each of which are allowed to ferment for between 24 and 48 hours. At the conclusion of final seed bioreactor, the mycelial biomass may be between approximately 2 g/L and 20 g/L, for example, 7 to 8 g/L. This seed fermentor may be inoculated into the aqueous media as described herein at a volume amount of between 5% and 50%, for example, at about 5%, about 10%, about 15%, about 20%, about 25%, about 30%, about 35%, about 40%, about 45%, about 50%. Growth of biomass may be confirmed by methods known in the art, such as for example pH drop or drop in dissolved oxygen (DO).

In some embodiments, the aqueous media represents a significant change in media and may induce a lag phase in the inoculated fungal culture. The inventors understand that the fermentation duration in the aqueous medium of the invention is shorter than the lag phase and therefore mycelial growth may not take place during the culturing step. However, organoleptic changes (decrease in undesirable tastes and/or aromas) as described herein are demonstrated to take place via human sensory testing.

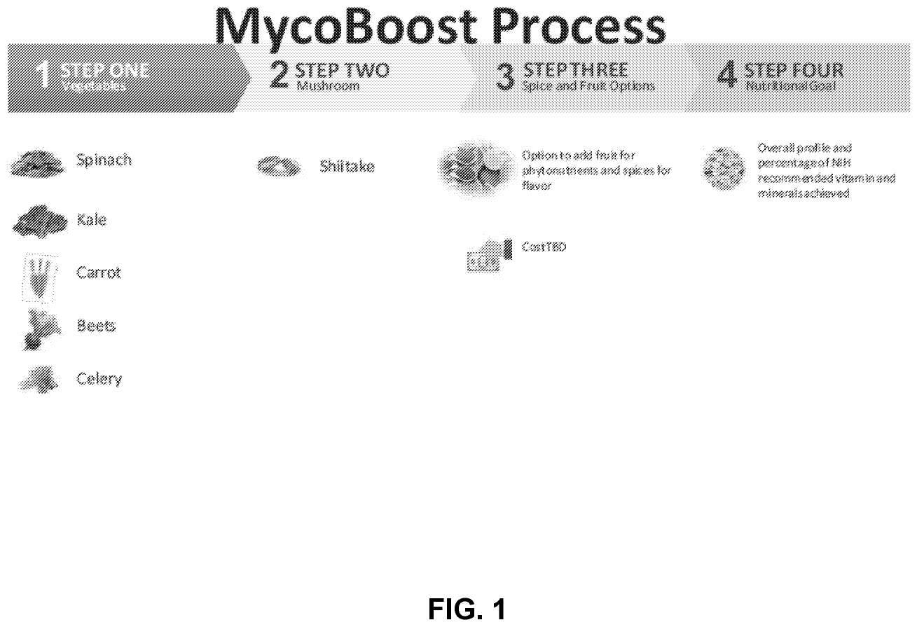

FIG. 1 shows an exemplification of the fermentation of H. erinaceus, L. edodes, C. sinensis, G. lucidum and L. sulphureus as the fungal component for high-nutrient vegetable and fruit products. In this embodiment, a 12 g/L of each vegetable (spinach, beet, carrot, kale and celery) and 40 g/L of chickpea power was used. After shaking for 5 days, cultures were harvested from shake flasks.

It was found that not all fungi can grow in media as described herein. Fungi useful for the present invention are from the higher order Basidio- and Ascomycetes. In some embodiments, fungi effective for use in the present invention include, but are not limited to the fungal culture comprises Lentinula edodes, Agaricus spp., Pleurotus spp., Boletus spp., or Laetiporus spp. In some embodiments, Laetiporus spp. is Laetiporus sulfureus, the Pleurotus spp. Pleurotus ostreatus, Pleurotus salmoneostramineus (Pleurotus djamor), Pleurotus eryngii, or Pleurotus citrinopileatus, Boletus spp. comprises Boletus edulis and Agaricus spp. comprises Agaricus blazeii, Agaricus bisporus. Agaricus campestris, Agaricus subrufescens, Agaricus brasiliensis or Agaricus silvaticus. Alternatively, fungi useful for the invention include Hericium erinaceus, Lentinula edodes, Cordyceps sinensis, Ganoderma lucidum, Laetiporus sulphureus, Laetiporus cincinnatus, Morchella angusticeps, Morchella importuna, Grifola frondosa, Ganoderma curtisii, Polyporus umbellatus, Volvariella volvacea, Fomes officianalis, Fistulina hepatica, Sparassia crispa, Inonotus obliquus, Cordyceps militaris, Agrocybe aegerita, Termitomyces albuminosus, Flammulina velutipes, Morchella esculenta, Hypsizygus tessellatus, Stropharia rugosoannulata, Pholiota nameko, Pleurotus eryngii, Boletus edulis, Morchella rufobrunnea, Morchella elata, Trametes versicolor, Canthrellas cibarius, Agaricus blazei, Clitocybe nuda, Pleurotus salmoneostramineus, Agaricus bisporus, Agaricus brunnescens, Tricholoma matsutake, Auricularia auricula, Tremella fuciformis and Hypsizygus ulmarius and combination of thereof.

In one embodiment, the fungus is Lentinula edodes. Fungi may be obtained commercially, for example, from the Penn State Mushroom Culture Collection. Strains are typically received as “master culture” PDY slants in 50 mL test tubes and are stored at all, but for A. blazeii, stored at 4° C. until plated. For plating, small pieces of culture are typically transferred into sterile shake flasks (e.g. 250 mL) so as not to contaminate the flask filled with a sterilized media (liquid media recipes are discussed below). Inoculated flasks shake for approximately ten hours and aliquots of said flasks are then plated onto prepared Petri plates of a sterile agar media. One flask can be used to prepare dozens to potentially hundreds of Petri plate cultures. There are other methods of propagating master culture though the inventors find these methods as disclosed to be simple and efficient.

Determining when to end the culturing step and to harvest the myceliated vegetable-containing product, which according to the present invention, to result in a myceliated vegetable-containing product with acceptable taste, flavor and/or aroma profiles, can be determined in accordance with any one of a number of factors as defined herein, such as, for example, visual inspection of mycelia, microscope inspection of mycelia, pH changes, changes in dissolved oxygen content, changes in protein content, amount of biomass produced, and/or assessment of taste profile, flavor profile, or aroma profile. In one embodiment, harvest can be determined by organoleptic tasting of the product to the desired taste. In one embodiment, harvest can occur when the dissolved oxygen reaches about 30% to about 80% dissolved oxygen, or less than about 80% of the starting dissolved oxygen. Additionally, mycelial products may be measured as a proxy for mycelial growth, such as, ergosterol, β-glucan and/or chitin formation. Other indicators include small molecule metabolite production depending on the strain (e.g. eritadenine on the order of 0.1-20 ppm for L. edodes or erinacine on the order of 20-70 ppm for H. erinaceus).

Harvest includes obtaining the myceliated vegetable-containing food product which is the result of the myceliation step. After harvest, cultures can be processed according to a variety of methods. In one embodiment, the myceliated vegetable-containing product is pasteurized or sterilized. In one embodiment, the myceliated vegetable-containing product is dried according to methods as known in the art. Additionally, concentrates and isolates of the material may be prepared using variety of solvents or other processing techniques known in the art. In one embodiment the material is pasteurized or sterilized, dried and powdered by methods known in the art. Drying can be done in a desiccator, microwave drying, vacuum dryer, conical dryer, spray dryer, fluid bed or any method known in the art. Preferably, methods are chosen that yield a dried myceliated vegetable-containing product (e.g., a powder) with the greatest digestibility and bioavailability. Low temperature drying is preferred, including low temperature vacuum spray drying, low temperature thin film drying (e.g., by microwave, near-infrared, for example, while holding temperature below 50° C., 40° C., 30° C., 20° C., 10° C., or 4° C.), as known in the art, and freeze-drying, in order to preserve nutrients. Some nutrients are sensitive to high temperatures and are preferably dried by lower temperature methods. The dried myceliated vegetable-containing product can be optionally blended, pestled, milled or pulverized, or other methods as known in the art.

In many cases, the flavor, taste and/or aroma of vegetable and fruit materials as disclosed herein, such as vegetable/fruit powders from vegetarian and fruit sources (e.g. carrot, spinach, kale, beet, celery, broccoli, aronia, grape skin, apple skin, cauliflower, sauerkraut, radish, kiwi, raspberry, cherry, mango, mandarin, banana, papaya, watercress, Chinese cabbage, chard, beet greens, chicory, leaf lettuce, parsley, romaine lettuce, collard greens, turnip greens, mustard greens, endive, chive, dandelion, sunflower, bell pepper, arugula, pumpkin, brussel sprout, scallion, kohlrabi, cabbage, winter squash (all varieties), rutabaga, turnip, leeks, sweet potato, fennel, swiss chard, okra, zucchini, avocado, bok choy, asparagus, pear, avocado, blueberry, blackberry, strawberry, raspberry, apricot, peach, red kale, purple beet, purple kale, rhodiola root, ashwagandha, coriander, cardamom, mint, turmeric, ascia, chokecherry, cinnamon, neem, aloe vera, anise, ajwain, turmeric, mustard seeds, cumin seeds, black pepper, kokum, tamarind, poppy seeds, ginger, Siberian ginseng, Asian ginseng, or a combination thereof) may have flavors/aromas which are often perceived as unpleasant, having pungent aromas and bitter or astringent tastes. These undesirable flavors, off-notes, and tastes are associated with their source(s) and/or their processing, and these flavors or tastes can be difficult or impossible to mask or disguise with other flavoring agents. The present invention, as explained in more detail below, works to modulate these tastes and/or flavors.

In one embodiment of the invention, flavors and/or tastes of the myceliated vegetable-containing product or products are modulated as compared to the starting material.

In one embodiment, the aromas of the resultant myceliated vegetable-containing food products prepared according to the invention are reduced and/or improved as compared to the vegetable/fruit mixture (starting material). In other words, undesired aromas are reduced, and/or desired aromas are increased. In another embodiment, flavors and/or tastes may be reduced and/or improved. For example, desirable flavors and/or tastes may be increased or added to the vegetable/fruit mixture material by the processes of the invention, resulting in myceliated high-nutrient products that have added mushroom, meaty, umami, buttery, and/or other flavors or tastes to the food product. The increase in desirable flavors and/or tastes may be rated as an increase of 1 or more out of a scale of 9 (1 being no taste, 9 being a very strong taste, 5 being the reference taste.)

In embodiments, the raw material (without myceliation) is red-brown in color, with a slight separation when wetted after 5 minutes. It is higher in filmy/grainy/pulpy and gritty and chalky mouthcoat than the product. It has a strong hay/grassy aroma and flavor, a chalky, dirt taste, and aftertastes of sweet, beet, and hay/herbal grassy and dirt. The product (myceliated vegetable-containing food product prepared according to the invention) has pea, mushroom, and cereal flavor notes, and has aftertastes of sour, umami, pea and mushroom.

Flavors and/or tastes of myceliated vegetable-containing products may also be improved by processes of the current invention. For example, deflavoring can be achieved, resulting in a milder flavor and/or with the reduction of, for example, bitter and/or astringent flavors, hay/herbal/grassy flavors, or beet flavors or tastes. Aromas may show decreased beet aromas and decreased hay/herbal/grassy aromas compared to the starting materials. The decrease in undesirable flavors and/or tastes as disclosed herein may be rated as a decrease of 1 or more out of a scale of 9 (1 being no taste, 9 being a very strong taste, 5 being reference).

In an embodiment, the myceliated vegetable-containing food product has the changed organoleptic perception as disclosed in the present invention, as determined by human sensory testing. It is to be understood that the methods of the invention only optionally include a step of determining whether the flavor of the myceliated vegetable-containing food product differs from a control material. The key determinant is, if measured by methods as disclosed herein, that the myceliated vegetable-containing food product provides and/or is capable of providing the named differences from control materials which have not been cultured with a fungus as named herein (e.g., sham fermentation).

Sensory evaluation is a scientific discipline that analyses and measures human responses to the composition of food and drink, e.g. appearance, touch, odor, texture, temperature and taste. Measurements using people as the instruments are sometimes necessary. The food industry had the first need to develop this measurement tool as the sensory characteristics of flavor and texture were obvious attributes that cannot be measured easily by instruments. Selection of an appropriate method to determine the organoleptic qualities, e.g., flavor, of the instant invention can be determined by one of skill in the art, and includes, e.g., discrimination tests or difference tests, designed to measure the likelihood that two products are perceptibly different. Responses from the evaluators are tallied for correctness, and statistically analyzed to see if there are more correct than would be expected due to chance alone.

In the instant invention, it should be understood that there are any number of ways one of skill in the art could measure the sensory differences.

In an embodiment, the myceliated vegetable-containing food product, e.g., produced by methods of the invention, has reduced flavors and/or aromas as described herein, as measured by sensory testing as known in the art. Such methods include change in taste threshold, change in bitterness intensity, and the like. At least 10% or more change (e.g., reduction in) bitterness is preferred. The increase in desirable flavors and/or tastes may be rated as an increase of 1 or more out of a scale of 5 (1 being no taste, 5 being a very strong taste.) Or, a reference may be defined as 5 on a 9 point scale, with reduced bitterness or at least one flavor as 1-4 and increased bitterness or at least one flavor as 6-9.

Culturing times and/or conditions can be adjusted to achieve the desired aroma, flavor and/or taste outcomes. As compared to the control sham fermentations and/or vegetable/fruit powder mixture, and/or the pasteurized, dried and powdered medium not subjected to sterilization or myceliation, the resulting myceliated vegetable-containing product in some embodiments is less bitter and has milder, less beet and less hay/herbal/grassy flavors and/or aromas.

The present invention also comprises a myceliated vegetable-containing product as defined herein. The myceliated vegetable-containing product can comprise, consist of, or consist essentially of at least 5%, at least 10%, at least 20%, at least 35%, at least 40%, at least 45%, at least 50%, at least 55%, at least 60%, at least 65%, at least 70%, at least 75%, at least 80%, at least 85%, at least 90%, or at least 95%, at least 100%, at least 150%, at least 200% of daily requirement (U.S. R.D.A.) of some vitamins and minerals.

In some embodiments, the myceliated vegetable-containing product may further include several vitamins/minerals and phytonutrients such as carotenoids and flavonoid, which may be obtained from vegetarian or fruit source as defined herein. In some embodiments, the myceliated high-nutrient product can be myceliated by a fungal culture as defined herein. In some embodiments, the myceliated high-nutrient product can have enhanced meaty, savory, umami, popcorn, and/or mushroom flavors, aromas and/or tastes as compared to the vegetable/fruit mixture as raw material. In other embodiments, the myceliated high-nutrient food product has decreased flavors, tastes and/or aromas (deflavoring) leading to a milder and/or an improved flavor, taste or aroma. In one embodiment reduced bitterness, astringency and/or hay/herbal/grassy tastes are observed.

In an embodiment, the present invention includes a method to prepare a myceliated vegetable-containing product. The steps of the method may include (a) providing an aqueous medium comprising 1-50 g/L dried carrot powder, 1-50 g/L dried spinach powder, 1-50 g/L dried broccoli powder, 1-50 g/L dried kale powder, and 1-50 g/L dried beet root powder, a ferrous salt and a potassium salt; (b) pasteurizing the aqueous medium; (c) inoculating the medium with a fungal culture comprising L. edodes; (d) culturing the medium to produce an improved myceliated vegetable-containing product, (e) exposing product of step (d) to UV light; (f) adding to the product of step (e) at least one of dried carrot powder at 1-50 g/l, Vitamin C, and Vitamin E; (g) pasteurizing the product of step (f); and (h) drying the product of step (g) by a low-temperature drying step. In an embodiment, the resulting myceliated vegetable-containing product has reduced beet and hay/herbal/grassy tastes, reduced beet and hay/herbal/grassy aromas, and has at least one of potassium at a level of least 40 mg/g dry weight, calcium at a level of at least 0.5 mg/g dry weight, magnesium at a level of at least 1.5 mg/g dry weight, iron at a level of at least 50 microgram/g dry weight, selenium at a level of at least 0.1 microgram/g dry weight, folate at a level of at least 0.5 microgram/g dry weight, Vitamin D at a level of at least 0.1 microgram/g dry weight, Vitamin A at a level of at least 1 RAE/g dry weight, Vitamin E at a level of at least 50 microgram/g dry weight, Vitamin K at a level of at least 1 microgram/g dry weight, or Vitamin C at a level of at least 0.1 mg/g dry weight. In embodiments, the myceliated vegetable-containing product contains all of the named nutrients herein.

The method steps disclosed herein can be performed in any order which accomplishes the objective of obtaining the myceliated vegetable product with the properties as claimed herein, e.g., optionally (i) reduced undesirable flavors and/or reduced undesirable aromas, compared to a non-myceliated vegetable-containing product, or (ii) a nutritional profile comprising a measurable level of at least one of potassium, calcium, magnesium, iron, selenium, folate, Vitamin D, Vitamin A, Vitamin E, or Vitamin C. For example, after the culturing step, the myceliated vegetable-containing product may be dried, e.g., freeze dried prior to an optional UV exposure step, or alternatively, the myceliated vegetable-containing product may be dried, e.g., freeze-dried after an optional UV exposure step. Also, for example, pasteurization and/or sterilization steps may be performed prior to or subsequent to any step in the process, e.g., to reduce microbial load (or CFU, colony forming units, count in the material).

The present invention also includes a myceliated vegetable-containing product prepared by any of the methods as disclosed herein. In an embodiment, the present invention also includes a myceliated vegetable-containing product comprising at least one vegetable substance as disclosed herein, optionally, a mixture of carrot, spinach, celery, kale, beet root; a fungal culture comprising a fungal culture as disclosed herein, optionally, L. edodes; and wherein the myceliated vegetable-containing product has e.g., reduced beet and hay/herbal/grassy flavors, and/or reduced beet and hay/herbal/grassy aromas, and/or has one or more of the following nutrients, or all of the following nutrients: potassium at a level of least 0.1, 0.5, 1, 2, 4, 6, 8, 10, 12, 14, 16, 18, 20, 22, 24, 26, 30, 32, 34, 36, 38, 40, 45, 50, 55, 60, 65, or 70 mg/g dry weight, and optionally no more than 100 mg/g, calcium at a level of at least 0.5, 1, 1.5, 2, 2.5, 3, 3.5, 4, 4.5, 5, 5.5, 6, 6.5, 7, 7.5, 8, 8.5, 9, 10, 20, or 30 mg/g dry weight, and optionally no more than 50 mg/g, magnesium at a level of at least 0.2, 0.4, 0.6, 0.8, 1.0, 1.2, 1.4, 1.6, 1.8, 2, 2.5, 3, 3.5, 4, 4.5 or 5 mg/g dry weight, and optionally no more than 10 mg/g, iron at a level of at least 10, 20, 30, 40, 50, 60, 70, 80, 90 or 100 microgram/g dry weight, and optionally, no more than 200 microgram/g, selenium at a level of at least 0.1, 0.2, 0.3, 0.4, 0.4, 0.5, or 1 microgram/g dry weight, and optionally, no more than 3 microgram/g, folate ata level of at least 0.2, 0.5, 0.6, 0.7, 0.8, 0.9, 1, 1.2, 1.4, 1.5 or 2 microgram/g dry weight, and optionally, no more than 10 microgram/g, Vitamin D at a level of at least 0.001, 0.002, 0.005, 0.01, 0.02, 0.04, 0.06, 0.08, 0.1, 0.15, 0.2 or 0.5 microgram/g dry weight, and optionally no more than 3 microgram/g, Vitamin A at a level of at least 0.5, 0.1, 0.2, 0.3, 0.4, 0.5, 0.6, 0.7, 0.8, 0.9, 1, 1.2, 1.4, 1.6, 1.8, 2 or 3 mg/g (beta-carotene) dry weight, and optionally, no more than 10 mg/g, Vitamin E at a level of at least 1, 2, 5, 10, 20, 30, 40, 50, 60, 70, 80, 90, 100, or 200 microgram/g dry weight, and optionally, no more than 500 mg/g; Vitamin K ata level of at least 0.5, 1, 1.5, 2, 2.5, 5, 3.5, 4, or 5 microgram/g dry weight, and optionally no more than 10 microgram/g; or Vitamin C at a level of at least 0.05, 0.1, 0.2, 0.3, 0.4, 0.5, 0.6, 0.7, 1, 2, 3, 4, 5, 6, 7, 8, 9 or 10 mg/g dry weight, and optionally, no more than 10 mg/g.

In embodiments, the potassium may be at least 10 mg/g, iron may be at least 0.05 mg/g, magnesium may be at least 1.5 mg/g, calcium may be at least 6 mg/g, selenium may be at least 0.1 microgram/g, Vitamin A may be at least 0.1 microgram/g (beta carotene), Vitamin C may be at least 0.1 mg/g, Vitamin K may be at least 2 microgram/g, folate may be at least 1 microgram/g, vitamin D may be at least 0.05 microgram/g, and vitamin E may be at least 20 microgram/g. Optionally, the nutrients included in the myceliated vegetable product may include potassium; iron; magnesium; Vitamin A, Vitamin C, folate, and Vitamin K. Alternatively, the nutrients included in the myceliated vegetable product may include potassium; magnesium, calcium, selenium, vitamin A, Vitamin C, folate, Vitamin D, and Vitamin E.

The present invention also includes a method of imparting nutrients to a food or a beverage, said method comprising the step of adding to said food or beverage a myceliated vegetable-containing product as defined herein. The present invention also includes a nutrient-improved food, comprising a myceliated vegetable-containing product as defined herein. Although the amount of a myceliated vegetable-containing product employed in a food or beverage will be dependent upon the e.g., nutritional profile that is desired in the food or beverage that is desired to be achieved, generally, an amount of about 1 to 50 g per serving of the food or beverage is desirable, such as, for example, 5 g, 10 g, 15 g, 20 g, 25 g, 30 g, 35 g, 40 g, 45 g, or 50 g.

Examples of foods or beverages include baked products, snack foods, cereal products, alcoholic and non-alcoholic beverages, spice blends, ready-to-heat foods, ready-to-eat meals, dairy products, meat products, seasoning preparations, ketchup, sauces, dried vegetables, soups, bouillon, noodles, frozen entrees, gravy, and desserts. Myceliated vegetable-containing product may be added to a food or beverage by simple mixing with other ingredients in the final blending of a food or beverage, such as a convenience food.

Alternatively, the myceliated vegetable-containing product may be added to the outside of a food or beverage, for example, the process of dusting or spray coating a snack food. Still further, the myceliated vegetable-containing product may be added to a food or beverage during its formation, in a process which is sometimes referred to as internal flavoring.

The myceliated vegetable-containing products of the present invention are well-suited for use, without limitation, in the following products: confectioneries, preferably selected from the group consisting of chocolate, chocolate bar products, other products in bar form, fruit gums, hard and soft caramels and chewing gum; baked products, preferably selected from the group consisting of bread, dry biscuits, cakes and other cookies; snack foods, preferably selected from the group consisting of baked or fried potato chips or potato dough products, bread dough products and corn or peanut-based extrudates;

Cereal products preferably selected from the group consisting of breakfast cereals, muesli bars and precooked finished rice products; alcoholic and non-alcoholic beverages, preferably selected from the group consisting of coffee, tea, wine, beverages containing wine, beer, beverages containing beer, liqueurs, schnapps, brandies, sodas containing fruit, isotonic beverages, soft drinks, nectars, fruit and vegetable juices and fruit or vegetable preparations; instant beverages, preferably selected from the group consisting of instant cocoa beverages, instant tea beverages and instant coffee beverages; spice blends and consumer prepared foods, including powder gravy, sauce mixes, condiments and fermented products; Ready-to-heat foods: ready meals and soups, preferably selected from the group consisting of powdered soups, instant soups, precooked soups; dairy products, milk products, preferably selected from the group consisting of milk beverages, ice milk, yogurt, kefir, cream cheese, soft cheese, hard cheese, powdered milk, whey, butter, buttermilk and partially or fully hydrolyzed milk protein containing products; flavored milk beverages; soya protein or other soybean fractions, preferably selected from the group consisting of soya milk and products produced therefrom, soya lecithin-containing preparations, fermented products such as tofu or tempeh or products produced therefrom and soy sauces.

Food products also include meat products, preferably selected from the group consisting of ham, fresh or raw sausage preparations, and seasoned or marinated fresh or salt meat products; eggs or egg products, preferably selected from the group consisting of dried egg, egg white and egg yolk and oil-based products or emulsions thereof, preferably selected from the group consisting of mayonnaise, remoulade, dressings and seasoning preparations; and fruit preparations, preferably selected from the group consisting of jams, sorbets, fruit sauces and fruit fillings; vegetable preparations, preferably selected from the group consisting of ketchup, sauces, dried vegetables, deep-frozen vegetables, precooked vegetables, vegetables in vinegar and preserved vegetables.

### Example 1

Five (5) 1 L baffled DeLong Erlenmeyer flasks were filled with 0.500 L of a medium consisting of 5 g/L pea protein concentrate, 5 g/L rice protein concentrate (labeled as 75-85% protein), 3 g/L maltodextrin, 3 g/l fruit puree, and 1 g/L carrot powder in RO water. The flasks were covered with a stainless-steel cap and sterilized in an autoclave on a liquid cycle that held the flasks at 120-123° C. for 1.5 hour. The flasks were carefully transferred to a clean HEPA laminar flow hood where they cooled for 4 hours and inoculated with 2 cm² pieces of mature Petri plate cultures of H. erinaceus, L. edodes, C. sinensis, G. lucidum and L. sulphureus (independently). All 4 flasks were placed on a shaker table at 150 rpm with a swing radius of 1″ at room temperature and allowed to incubate for 8-13 days. These inoculum cultures were then transferred to five (5) 1 L baffled DeLong Erlenmeyer flasks were filled with 0.500 L of a medium 6 g of carrot powder, 6 g spinach powder, 6 g celery powder, 6 g of kale powder, 6 g, beet root powder and 20 g chick pea powder and incubated for 5 days. A microscope check was done to ensure the presence of mycelium (mycelial pellets were visible by the naked eye) and the culture was plated on LB media to ascertain the extent of any bacterial contamination and none was observed. These cultures were pasteurized for 60 minutes at 65 C and organoleptic tasting was conducted to determine optimal flavor strain. Organoleptic testing showed that all materials had increased desirable flavors and desirable aromas, and decreased undesirable flavors and undesirable aromas. Specifically, H. erinaceus had reduced bitterness, astringency, beany, grassy and weedy tastes, and reduced beany, grassy and weedy aromas, and increased mushroom aroma and increased umami, mushroom, and savory tastes. These changes together resulted in a milder taste/aroma than the starting material. This culture also developed a sour flavor as myceliation was allowed to proceed. L. edodes had reduced bitterness, astringency, beany, grassy and weedy tastes and reduced beet aroma, reduced hay/herbal/grassy aroma, and increased mushroom aroma and tastes, and increased umami and savory tastes. This culture could be described as having an increased sweet flavor or an increased neutral flavor. These changes together resulted in a milder taste/aroma than the starting material. C. sinensis had the changes described for L. edodes, to a lesser extent, and also had increased fungal notes. G. lucidum had the changes described for L. edodes but to a lesser extent, with increased tart notes and mushroom flavor/aroma. L. sulphureus had the changes described for L. edodes but to a lesser extent, and had increased hickory aroma.

### Example 2

A 7 L bioreactor was filled with 4.5 L of a medium consisting 12 g/L of carrot powder, 12 g/L spinach powder, 12 g/L celery powder, 12 g/L of kale powder, 12 g/L, beet root powder and 40 g/L of chick pea powder. Any open port on the bioreactor was wrapped with tinfoil and sterilized in an autoclave that held the bioreactor at 120-123° C. for 2 hours. The bioreactor was carefully transferred to a clean bench in a cleanroom, setup and cooled for 4-6 hours. The bioreactor was inoculated with 225 mL of inoculant from a 13-day old flask as prepared in Example 1, using L. edodes. The bioreactor had an air supply of 3.37 L/min (0.75 VVM) and held at 26° C. Bioreactor was agitated at 150 rpm. Samples were examined by microscope at 40 hours, 42 hours and 44 hours. A microscope check was done to ensure the presence of mycelium (mycelial pellets were visible by the naked eye) and the culture was plated on LB media to ascertain the extent of any bacterial contamination and none was observed. These cultures were pasteurized for 60 minutes at 65° C. and organoleptic taste was done with 44 hours showed the best tasting. See FIG. 1 for summary of aspects of the process.

### Example 3

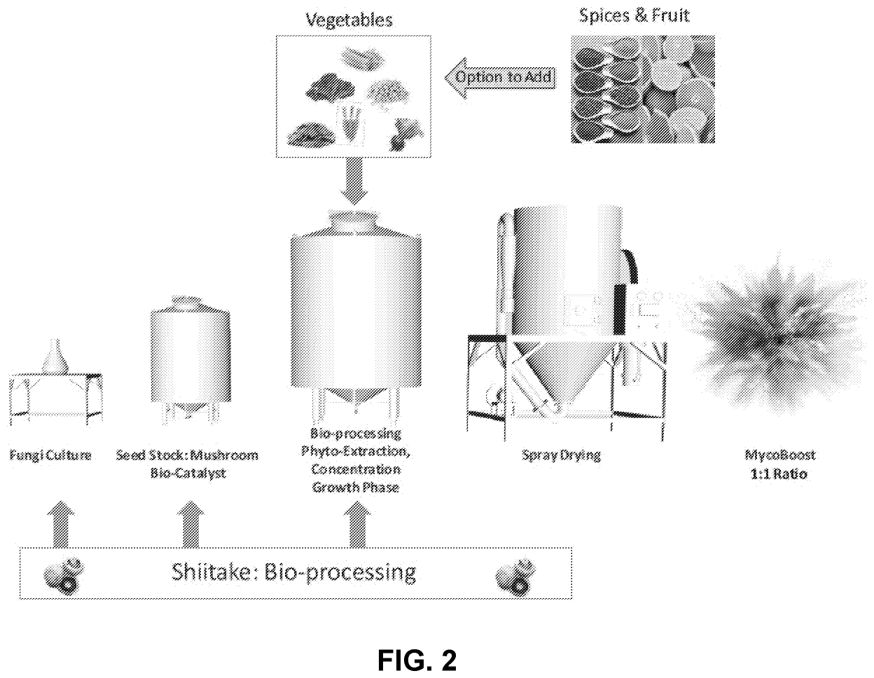

A 250 L bioreactor was filled with 115 L of a medium consisting of 12 g/L of carrot powder, 12 g/L spinach powder, 12 g/L celery powder, 12 g/L g of kale powder, 12 g/L, beet root powder and 40 g/L of Chickpea powder and sterilized in place by methods known in the art, being held at 120-121° C. for 100 minutes. The bioreactor was inoculated with 4 L of inoculant L. edodes from four 4 L flask, prepared as described in Example 1. The bioreactor was held at 26° C. Samples were taken at 41 hours, 42 hours and 44 hours for organoleptic tasting. The culture was harvested at 44 hours upon successful visible (mycelial pellets) and microscope checks. The pH of the culture did not change during processing. The culture was plated on LB media to ascertain the extent of any bacterial contamination and none was observed. The culture was then pasteurized at 70° C. for 30 minutes with a ramp up time of 30 minutes and a cool down time of 45 minutes to 10° C. The culture was finally spray dried and tasted. The final product was noted to have a pleasant aroma with no perceptible taste at concentrations up to 20%. See FIG. 2 for a schematic representation of aspects of the process.

### Example 4

One (1) 1 L baffled DeLong Erlenmeyer flasks were filled with 0.500 L of a medium consisting of 5 g/L pea protein concentrate (labeled as 75-85% protein), 5 g/L rice protein concentrate (labeled as 75-85% protein), 3 g/L maltodextrin, 3 g/L fruit puree, and 1 g/L carrot powder in RO water. The flasks were covered with a stainless-steel cap and sterilized in an autoclave on a liquid cycle that held the flasks at 120-123° C. for 1.5 hour. The flasks were carefully transferred to a clean HEPA laminar flow hood where they cooled for 4 hours and inoculated with mature Petri plate cultures of L. edodes. This flask was placed on a shaker table at 150 rpm with a swing radius of 1″ at room temperature and allowed to incubate for 8-15 days. This inoculum culture was then transferred to one 7 L bioreactor prepared as example 2 and filled with 4.5 L of a medium consisting 15 g/L of carrot powder, 15 g/L spinach powder, 15 g/L Celery powder, 15 g/L of kale powder, 15 g/L, beet root powder and 50 g/l of chick pea powder and one bioreactor prepared as example 2 and filled with 18 g/L of carrot powder, 18 g/L spinach powder, 18 g/L broccoli powder, 18 g/L of kale powder, 18 g/L beet root powder and 60 g/l of chick pea powder and one bioreactor prepared as example 2 and filled with 24 g/L of carrot powder, 24 g/L spinach powder, 24 g/L broccoli powder, 24 g/L of kale powder, 24 g/L, beet root powder and 80 g/l of chick pea powder.

### Example 5

Four (4) 1 L baffled DeLong Erlenmeyer flasks were filled with 0.500 L of a medium consisting of 5 g/L pea protein concentrate, 5 g/L rice protein concentrate (labeled as 75-85% protein), 3 g/L maltodextrin, 3 g/l fruit puree, and 1 g/L carrot powder in RO water. The flasks were covered with a stainless-steel cap and sterilized in an autoclave on a liquid cycle that held the flasks at 120-123° C. for 1.5 hour. The flasks were carefully transferred to a clean HEPA laminar flow hood where they cooled for 4 hours and inoculated with mature Petri plate cultures of A blazei, G. frondosa, S. crispa, and M. esculenta. All 4 flasks were placed on a shaker table at 150 rpm with a swing radius of 1″ at room temperature and allowed to incubate for 8-15 days. These inoculum cultures were then transferred to four (4) 1 L baffled DeLong Erlenmeyer flasks were filled with 0.500 L of a medium 6 g of carrot powder, 6 g spinach powder, 6 g broccoli powder, 6 g of kale powder, 6 g, beet root powder and 20 g chick pea powder and incubated for 5 days. These flasks were harvested and dried after five days of incubation. A microscope check was done to ensure the presence of mycelium (mycelial pellets were visible by the naked eye) and the culture was plated on LB media to ascertain the extent of any bacterial contamination and none was observed. These cultures were pasteurized for 60 minutes at 65 C and organoleptic tasting was conducted to determine optimal flavor strain. The materials produced by this method had reduced bitterness, astringency, beany, grassy and weedy tastes, and reduced beany, grassy and weedy aromas, reduced beet aroma, reduced hay/herbal/grassy aroma, and increased mushroom aroma and tastes, and increased umami and savory tastes. These changes together resulted in a milder taste/aroma than the starting material.

### Example 6

Material from Example 4 was sent to a 3^{rd} party sensory group to objectively assess the sensory impact of the processes described in these examples on the raw materials used in the production of the myceliated materials made according to the example. The sensory panel tasted and assessed the raw mixture of vegetables powder and chickpea used in the production of the myceliated high protein food compositions produced in (18) tasters ranked various attributes on a 0-150-point scale of intensity relative to known standards. The data from the study showed that the astringent and bitter flavor of vegetable powder mixed was completely absent in the myceliated composition (each aroma ranked ˜70-90 on the 150-point scale in the protein concentrates and 20 in the myceliated products). To the inventors' knowledge, this is the first example of a process that completely removes vegetable aromas and develops mushroom aromas and an umami taste in the processed vegetable and fruit material. Other attributes were analyzed but these were the primary differences between the raw powders and myceliated product.

### Example 7

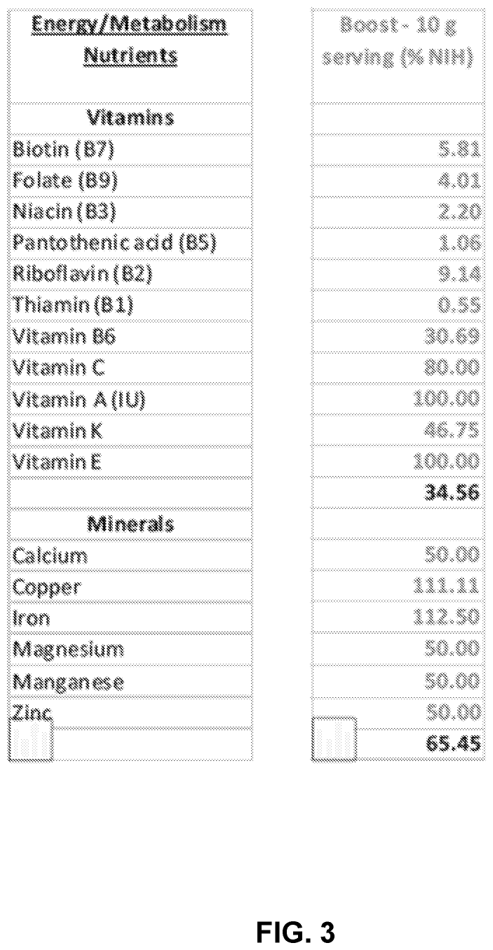

Nutritional value assessment was done for the product as produced in Example 3 for several vitamins and minerals including Biotin, folate, niacin, pantothenic acid, riboflavin, thiamin, vitamin B6, vitamin B12, vitamin C, vitamin A. Vitamin E, vitamin K, calcium, copper, iodine, iron, magnesium, manganese, phosphorus, carotenoids and flavonoids. Results showed that for a dose of 10 g a daily requirement of some of these vitamins such as Vitamin K can be fulfilled up to 100%. A significant presence of flavonoids and carotenoids support the antioxidant compound needs. See FIG. 3 for measurements of nutrients from a sample of produced material.

### Example 8

A 250 L bioreactor was filled with 115 L of a medium consisting of

| Medium component | Concentration (g/L) |
|---|---|
| Spinach Powder | 14.0 |
| Broccoli Powder | 14.0 |
| Kale Powder | 14.0 |
| Red Beet Powder | 14.0 |

Media Preparation. Using the recipe from above, only water, and anti-foam were added before sterilization. The remainder of the media components were added post-sterilization, and pasteurized at 70° C. for 75 minutes to minimize the amount of possible contamination, without compromising the vitamins/nutrients. Once pasteurized, the material was cooled down and inoculated with 10% v/v inoculum prepared as described in Example 1. The inoculum was approximately between about 7-8 g/L biomass at the time of inoculation.

Fermentation.

The main fermenter temperature was approximately 25-27° C., initial pH typically 5.5-5.7 pH, DO approximately greater than 90%. Fermentation was conducted for a period of 16 hours with air sparging and under agitation. Fermentation completion was confirmed by an observable level of myceliation by microscope at 100×-1000×, pH change of at least 0.5 pH units (drop), and change in DO of more than 10%.

Following fermentation, the contents of the fermentor were heated to about 65° C. over 75 minutes to terminate the fermentation, and then spray dried. The spray dried material was exposed to UV light using the BT Lab System, Model 502, BT Lab Systems UV Transilluminators. UV wavelength: 302 nm, UV Tubes: 5×8 W, Power: 100-240V, 50-60 Hz, exposure pan has dimension of 8 inch by 6.5 inches, using 12 cycles (250 seconds each). This resulted in a Vitamin D content (per 10 g solid material) of 0 micrograms prior to exposure, with 0.8 microgram produced after 4 UV cycles, 2.9 micrograms after 8 UV cycles, and 3.5 microgram after 12 UV cycles. For a 40 W exposure for 16.6 min, 33.2 min and 50.8 min, this corresponds to 39.84 KJ/surface area or 79.68 KJ/surface area or 119.52 KJ/surface area, respectively. Since surface area is 16 mm×20 mm or 320 cm² or 0.32 m². The actual exposure would be 124.5 KJ/m², 249 KJ/m2, or 373.4 KJ/m².

At that time carrot powder 14 g/L, Vitamin C at 200 mg/L and Vitamin E at 30 g/L (all amounts relative to the initial media concentrations) was added.

The final amounts of nutrients were calculated at 171.3 mg calcium, 103.2 mg magnesium, 50 micrograms Vitamin A as RAE, potassium at 760 mg, Vitamin D at 1.96 microgram, and Vitamin E at 0.3 mg, per 30 g material.

The materials produced by this method had reduced bitterness, beet, hay/herbal/grassy tastes, and reduced bitterness, beet, hay/herbal/grassy aroma, and increased mushroom aroma and tastes, and increased umami and savory tastes. These changes together resulted in a milder taste/aroma than the starting material.

### Example 9

A 250 L bioreactor is filled with 115 L of a medium consisting of

| Medium component | Concentration (g/L) |
|---|---|
| Spinach Powder | 14.0 |
| Broccoli Powder | 14.0 |
| Kale Powder | 14.0 |
| Red Beet Powder | 14.0 |

Media Preparation. Using the recipe from above, only water, and anti-foam are added before sterilization. The remainder of the media components are added post-sterilization, and are pasteurized at 70° C. for 75 minutes to minimize the amount of possible contamination, without compromising the vitamins/nutrients. Once pasteurized, the material is cooled down and is inoculated with 30% v/v inoculum prepared as described in Example 1. The inoculum is approximately 7-8 g/L biomass.

Fermentation.

The main fermenter temperature is approximately 25-27° C., initial pH typically 5.5-5.7 pH, DO approximately greater than 90%. Fermentation was conducted for a period of 16 hours with air sparging and under agitation. Fermentation completion is confirmed by an observable level of myceliation by microscope at 100×-1000×, pH change of at least 0.5 pH units (drop), and change in DO of more than 10%. The total dissolved solids should be about 6.8-7.4%.

Following fermentation the contents of the fermentor are circulated through a tube exposed to UV light sufficient to create at least 3 micrograms Vitamin D per 10 g dried solid material. After completion of the UV treatment, carrot powder 14 g/L, Vitamin C at 200 mg/L and Vitamin E at 30 g/L (relative to the original media and adjusted for the total amount of media) are added to the contents of the fermentor.

The bioreactors are then pasteurized at 70° C. for 75 minutes and cooled down. The fermentation medium is collected and then immediately frozen at −20° C. The frozen harvests are then collected and dried by low temperature infrared thin film drying at less than 50° C., followed by milling. The final amounts of nutrients are calculated at 281.2 mg calcium, 66 mg magnesium, 170.1 micrograms Vitamin A as RAE, potassium at 863 mg, Vitamin D at 1.96 microgram, and Vitamin E at 2.9 mg, per 30 g solid.

The materials produced by this method have reduced bitterness, beet, hay/herbal/grassy tastes, and reduced bitterness, beet, hay/herbal/grassy aroma, and increased mushroom aroma and tastes, and increased umami and savory tastes. These changes together result in a milder taste/aroma than the starting material.

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, though the present invention has been specifically disclosed by preferred embodiments, exemplary embodiments and optional features, modification and variation of the concepts herein disclosed may be resorted to by those skilled in the art, and that such modifications and variations are within the scope of this invention as defined by the appended claims. The specific embodiments provided herein are examples of useful embodiments of the present invention and it will be apparent to one skilled in the art that the present invention may be carried out using many variations of the devices, device components, methods steps set forth in the present description. As will be obvious to one of skill in the art, methods and devices useful for the present methods can include many optional composition and processing elements and steps.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter is claimed, compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein, any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, although the present invention has been specifically disclosed by preferred embodiments and optional features, modification and variation of the concepts herein disclosed may be resorted to by those skilled in the art, and that such modifications and variations are within the scope of this invention as defined by the appended claims.

We claim:

1. A method to prepare a myceliated vegetable-containing product, comprising the steps of:
(a) providing an aqueous medium comprising at least one vegetable substance;
(b) inoculating the medium with a fungal culture, wherein the fungal culture comprises Agaricus spp., Pleurotus spp., Boletus spp., or Laetiporus spp.; or wherein the fungal culture comprises Lentinula edodes, Hericium erinaceus, Inonotus obliquus, Ganoderma lucidum, or Cordyceps sinensis; and
(c) culturing the medium to produce a myceliated vegetable-containing product,
wherein the myceliated vegetable-containing product has (i) reduced undesirable flavors and/or reduced undesirable aromas, compared to a non-myceliated vegetable-containing product, or (ii) a nutritional profile comprising a measurable level of at least one of potassium, calcium, magnesium, iron, selenium, folate, Vitamin D, Vitamin A, Vitamin E, or Vitamin C.

2. The method of claim 1, wherein the myceliated vegetable product has reduced undesirable flavors, reduced undesirable aromas, and a measurable level of at least one of potassium, calcium, magnesium, iron, selenium, folate, Vitamin D, Vitamin A, Vitamin E, or Vitamin C.

3. The method of claim 2, wherein the myceliated vegetable product has Vitamin D at a level of at least 0.1 microgram/g dry weight.

4. The method of claim 1, wherein the myceliated vegetable product has at least one of one of potassium at a level of least 10 mg/g dry weight, calcium at a level of at least 0.5 mg/g dry weight, magnesium at a level of at least 1.5 mg/g dry weight, iron at a level of at least 50 microgram/g dry weight, selenium at a level of at least 0.1 microgram/g dry weight, folate at a level of at least 0.5 microgram/g dry weight, Vitamin D at a level of at least 0.05 microgram/g dry weight, Vitamin A at a level of at least 1 microgram/g dry weight, Vitamin E at a level of at least 20 microgram/g dry weight, Vitamin K at a level of at least 1 microgram/g dry weight, or Vitamin C at a level of at least 0.1 mg/g dry weight.

5. The method of claim 1, wherein the aqueous media comprises between about 5 g to about 100 g (dry weight) vegetable substance in total per L aqueous medium.

6. The method of claim 1, wherein the vegetable substance comprises one or more of carrot, spinach, kale, beet, celery, broccoli, aronia, grape skin, apple skin, cauliflower, sauerkraut, radish, kiwi, raspberry, cherry, mango, mandarin, banana, papaya, watercress, Chinese cabbage, chard, beet greens, chicory, leaf lettuce, parsley, romaine lettuce, collard greens, turnip greens, mustard greens, endive, chive, dandelion, sunflower, bell pepper, arugula, pumpkin, brussel sprout, scallion, kohlrabi, cabbage, winter squash (all varieties), rutabaga, turnip, leeks, sweet potato, fennel, swiss chard, okra, zucchini, avocado, bok choy, asparagus, pear, avocado, blueberry, blackberry, strawberry, raspberry, apricot, peach, red kale, purple beet, purple kale, rhodiola root, ashwagandha, coriander, cardamom, mint, turmeric, ascia, chokecherry, cinnamon, neem, aloe vera, anise, ajwain, turmeric, mustard seeds, cumin seeds, black pepper, kokum, tamarind, poppy seeds, ginger, Siberian ginseng, Asian ginseng, or a combination thereof.

7. The method of claim 1, wherein the vegetable substance comprises a dried vegetable powder.

8. The method of claim 1, wherein the vegetable substance comprises a mixture of dried or fresh spinach, broccoli, kale, and beet root.

9. The method of claim 8, wherein the aqueous media comprises 1-50 g/L spinach powder, 1-50 g/L broccoli powder, 1-50 g/L kale powder, and 1-50 g/L beet root powder.

10. The method of claim 1, wherein the improved nutritional profile comprises increased amounts of or increased bioavailability of flavonoids, carotenoids or other phytonutrients.

11. The method of claim 1, wherein the Laetiporus spp. is Laetiporus sulfureus, wherein the Pleurotus spp. comprises Pleurotus ostreatus, Pleurotus salmoneostramineus (Pleurotus djamor), Pleurotus eryngii, or Pleurotus citrinopileatus, wherein Boletus spp. comprises Boletus edulis and wherein Agaricus spp. comprises Agaricus blazeii, Agaricus bisporus. Agaricus campestris, Agaricus subrufescens, Agaricus brasiliensis or Agaricus silvaticus.

12. The method of claim 10, wherein the fungal culture comprises L. edodes.

13. The method of claim 1, wherein the reduced undesirable flavor comprises a reduced beet, bitter, astringent, hay/herbal/grassy taste.

14-18. (canceled)

19. The method of claim 1, further comprising step (d), exposing the myceliated vegetable-containing product to UV light sufficient to convert a proportion of the myceliated vegetable-containing product's ergosterol to Vitamin D.

20. The method of claim 19, further comprising step (e), adding to the UV-treated myceliated vegetable-containing product a material selected from the group consisting of fresh or dried carrot powder, Vitamin E, and Vitamin C.

21-25. (canceled)

26. The method of claim 1, wherein the medium additionally comprises an ingredient selected from the group consisting of a ferrous salt and a potassium salt.

27. A method to prepare a myceliated vegetable-containing product, comprising the steps of:
(a) providing an aqueous medium comprising 1-50 g/L dried carrot powder, 1-50 g/L dried spinach powder, 1-50 g/L dried broccoli powder, 1-50 g/L dried kale powder, and 1-50 g/L dried beet root powder, a ferrous salt and a potassium salt;
(b) pasteurizing the aqueous medium;
(c) inoculating the medium with a fungal culture comprising L. edodes;
(d) culturing the medium to produce an improved myceliated vegetable-containing product,
(e) exposing product of step (d) to UV light;
(f) adding to the product of step (e) at least one of dried carrot powder at 1-50 g/l, Vitamin C, and Vitamin E;
(g) pasteurizing the product of step (f); and
(h) drying the product of step (g) by a low-temperature drying step,
wherein the myceliated vegetable product has at least one of one of potassium at a level of least 10 mg/g dry weight, calcium at a level of at least 0.5 mg/g dry weight, magnesium at a level of at least 1.5 mg/g dry weight, iron at a level of at least 50 microgram/g dry weight, selenium at a level of at least 0.1 microgram/g dry weight, folate at a level of at least 0.5 microgram/g dry weight, Vitamin D at a level of at least 0.05 microgram/g dry weight, Vitamin A at a level of at least 1 microgram/g dry weight, Vitamin E at a level of at least 20 microgram/g dry weight, Vitamin K at a level of at least 1 microgram/g dry weight, or Vitamin C at a level of at least 0.1 mg/g dry weight.

28. A myceliated vegetable-containing product prepared by the method of claim 1.

29. A myceliated vegetable-containing product comprising a mixture of carrot, spinach, celery, kale, beet root, and a fungal culture comprising L. edodes;
wherein the myceliated vegetable-containing product has reduced beet and hay/herbal/grassy tastes, reduced beet and hay/herbal/grassy aromas, and wherein the myceliated vegetable product has at least one of one of potassium at a level of least 10 mg/g dry weight, calcium at a level of at least 0.5 mg/g dry weight, magnesium at a level of at least 1.5 mg/g dry weight, iron at a level of at least 50 microgram/g dry weight, selenium at a level of at least 0.1 microgram/g dry weight, folate at a level of at least 0.5 microgram/g dry weight, Vitamin D at a level of at least 0.05 microgram/g dry weight, Vitamin A at a level of at least 1 microgram/g dry weight, Vitamin E at a level of at least 20 microgram/g dry weight, Vitamin K at a level of at least 1 microgram/g dry weight, or Vitamin C at a level of at least 0.1 mg/g dry weight.

30. (canceled)

31. A nutrient-improved food, comprising a myceliated vegetable-containing product as defined in claim 28.
